(19) United States
(12) Patent Application Publication
(10) Pub. No.: US 2024/0070499 A1
(43) Pub. Date: Feb. 29, 2024

(54) Quantum Computing Method

(71) Applicant: Multiverse Computing S.L., Donostia / San Sebastian (ES)

(72) Inventors: Román Orús, DONOSTIA / SAN SEBASTIAN (ES); Rodrigo Hernandez, DONOSTIA / SAN SEBASTIAN (ES); Cristina Sanz, DONOSTIA / SAN SEBASTIAN (ES)

(21) Appl. No.: 17/896,841

(22) Filed: Aug. 26, 2022

(51) Int. Cl. G06N 10/20

(52) U.S. Cl. CPC G06N 10/20

(57) ABSTRACT

A method and system for establishing a circuit configuration for a data set to carry out a quantum computation on a quantum processor (50) is disclosed. The method comprises ingesting (S205) data values of the data set, fitting (S220) the data values to a function f(i) and converting (S230) the data values to qubits (q₀-q₃) by rotations.

### BACKGROUND OF THE INVENTION

### Field of the Invention

The invention relates to quantum computing devices and more specifically to quantum computing methods to establish a circuit configuration to carry out a quantum computation.

### Brief Description of the Related Art

The subject disclosure relates to quantum computing devices, and more specifically, combining quantum computing techniques with stochastic control problems.

Methods for establishing circuit configurations to carry out a quantum computation are known in the art. For example, international patent application WO2020064329 A1 (IBM) teaches techniques for facilitating utilizing a quantum computing circuit in con/junction with a stochastic control problem. A system is provided that comprises a quantum computing circuit that prepares a quantum state that represents a stochastic control problem. The system of this patent application can further comprise a classical computing device that determines parameters for the quantum computing circuit.

### SUMMARY OF THE INVENTION

One of the biggest challenges in quantum computing is the effort that is required to processing the input data and establish a circuit configuration to carry out a quantum computation. The idea behind the method outlined in this document is to simplify the process. This simplification is carried out by abstracting the preprocessing and data preparation stage into a pre-processing module.

The method for establishing a circuit configuration for a data set to carry out a quantum computation on a quantum processor comprises a step of ingesting data values of the data set and then fitting the data values to a function.

In one aspect the data values are converted to qubits by encoding, such as angle encoding of the qubits and, in one non-limiting aspect, using Y-rotations.

In one aspect, the data values are cleansed prior to fitting and in another aspect, the data values are normalized.

In one aspect the method further comprises integrating by applying the qubits to an ancillary qubit in the quantum processor. In another aspect a value then can be read out from the ancillary qubit.

In one aspect the function f(i) is a stochastic function.

According to another aspect there is provided a system for establishing a circuit configuration for a data set to carry out a quantum computation on a quantum processor. The system comprises a plurality of input/output devices for reading data values of the data set, and a central processing unit for fitting the data values to the function (e.g., the stochastic function) and encoding the data values to qubits. A quantum processor is used for processing the qubits; and a read-in/read out element is provided for passing the data values for processing to the quantum processor and reading out a result.

In one aspect of the system the data values are encoded by angle encoding of the qubits.

### DESCRIPTION OF THE FIGURES

For a more complete understanding of the present invention and the advantages thereof, reference is now made to the following description and the accompanying drawings, in which:

FIG. 1 shows an overview of a quantum computing system.

FIG. 2 shows a flow diagram of a method.

FIG. 3 shows a representation of an exemplary function.

FIG. 4 shows a graphical representation of the state preparation.

FIG. 5 shows a graphic representation of the quantum calculation.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

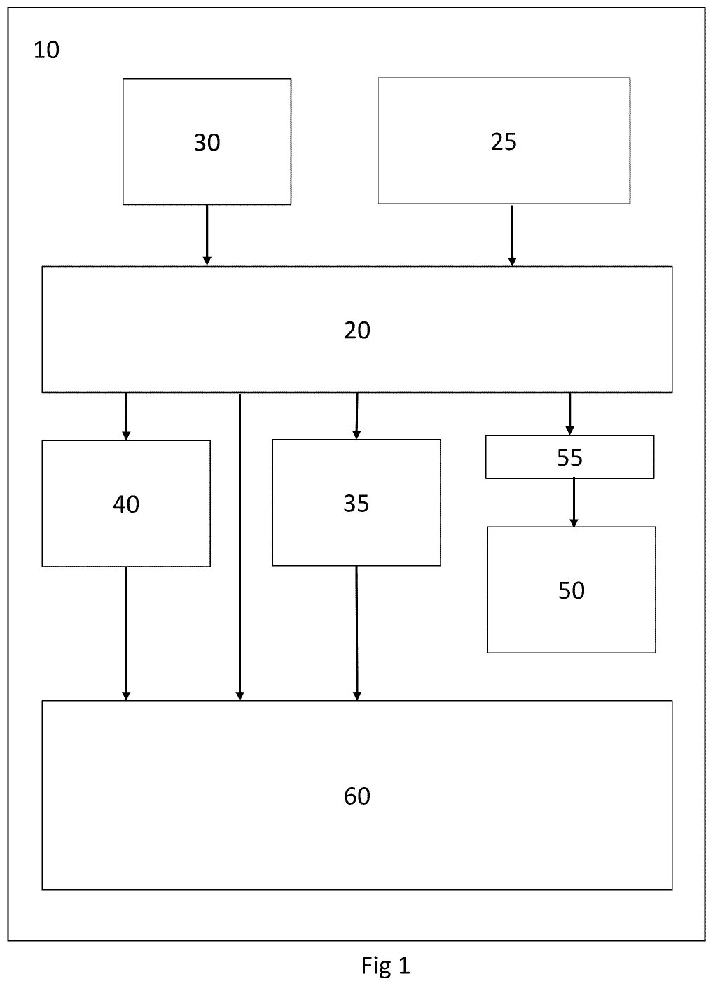

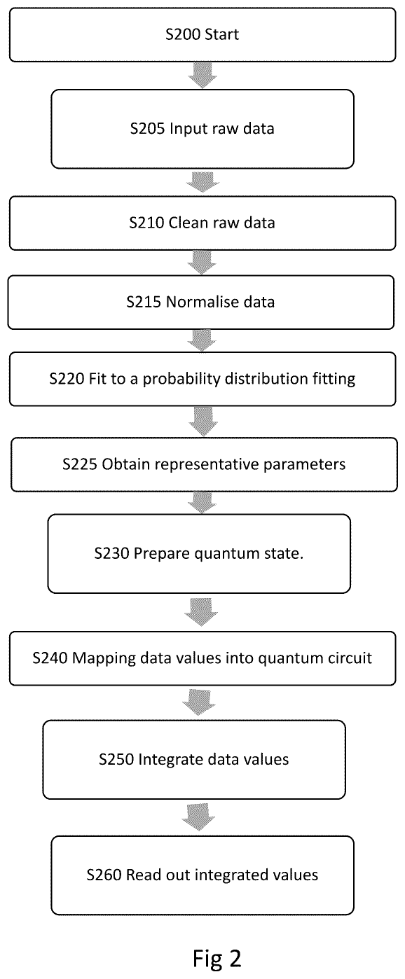

FIG. 1 shows an overview of a computing system 10 for implementing the method of this document. The computing system 10 is a hybrid quantum and classical system and comprises, in an example, a central processing unit 20 which is connected to a data storage unit 25 (i.e., one or more memory devices), and input/output devices 30. A graphics processing unit 35 for processing vector calculations and a field programmable gate array (FGPA) 40 for control logic are connected to the central processing unit 20. A quantum processor 50 (also termed quantum accelerator) is connected to the central processing unit 20 through a read-in/read-out element 55.

In one implementation of the computing system 10, the quantum processor 50 can be a gate-based quantum computer, such as one supplied by IonQ, College Park, Maryland, but this is not limiting of the invention. The computing system 10 is connected to a computer network 60, such as the Internet. It will be appreciated that the computing system 10 of FIG. 1 is merely exemplary and other units or elements may be present in the computing system 10. It will also be appreciated that there may be many input/output (I/O) devices 30 located at multiple locations and that there may be a plurality of data storage units 25 also located at multiple locations. The many I/O devices 30 and data storage units 25 are connected by the computer network 60.

State preparation is the process of translating a formulation of a quantum input problem into a very specific quantum circuit configuration. In other words, the input problem function needs to be represented in terms of a quantum circuit. The document describes a data pipeline that automates the process of, for example, generating the state preparation for stochastic problems with multivariate distributions. However, the method is not limited to such stochastic problems.

In order to configure the state preparation, there are several parameters that will need to be defined for use in the state preparation. These several parameters depend on the type of stochastic function and the input (or raw) data which is represented by the stochastic function. The raw data can be fitted to distributions, such as but not limited to, gaussian, normal, exponential, Poisson, using machine learning regression methods for example. In the non-limiting example of this document, the focus is placed on the state preparation for quantum circuits approximating the mean output value of algorithms bounded, for example, between zero and one. It will be appreciated that the method of this document is not limited to the boundaries between zero and one. It would be possible to use other boundaries and, after the state preparation, rescaling to actual mean values boundaries is possible.

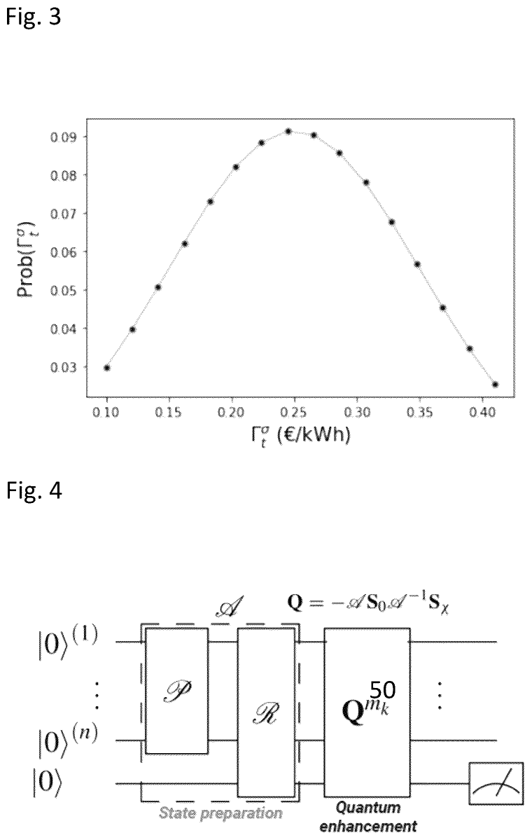

The equation employed for the quantum state preparations is following:

$$\vert ψ 〉 = {\sum }_{i - 0}^{{2}^{n} - 1} \sqrt{p ( i )} \vert i {〉}_{n} ( \sqrt{1 - f ( 1 )} \vert 0 〉 + \sqrt{f ( i )} \vert 1 〉 )$$

where |ψ [symbol] is the wave function and its derivation will be explained below, n is the number of qubits and p is the probability distribution that the problem input function f follows. This will be explained in more detail in an example in connection with FIGS. 3-5.

FIG. 3 shows a plot with 16 measured values and illustrates a graphical representation of the stochastic function for which the mean output value is to be found. The measured values are normally distributed on the graph of FIG. 3; however, exponential, Gaussian, Poisson, and other distribution are suited. This case shows on the x-axis the cost of energy in Euros per kWhours against the measured probability on the y-axis, but the invention is not limited to this use case. This use case is used to illustrate the manner in which the state preparation is carried out. The mean value E[f] of an input problem stochastic function f(i) is given by:

$$E [ f ] = {\sum }_{i = 0}^{N - 1} p ( i ) \cdot f ( i )$$

where the probability p(i) is the probability of the value f(i) of the function f at i.

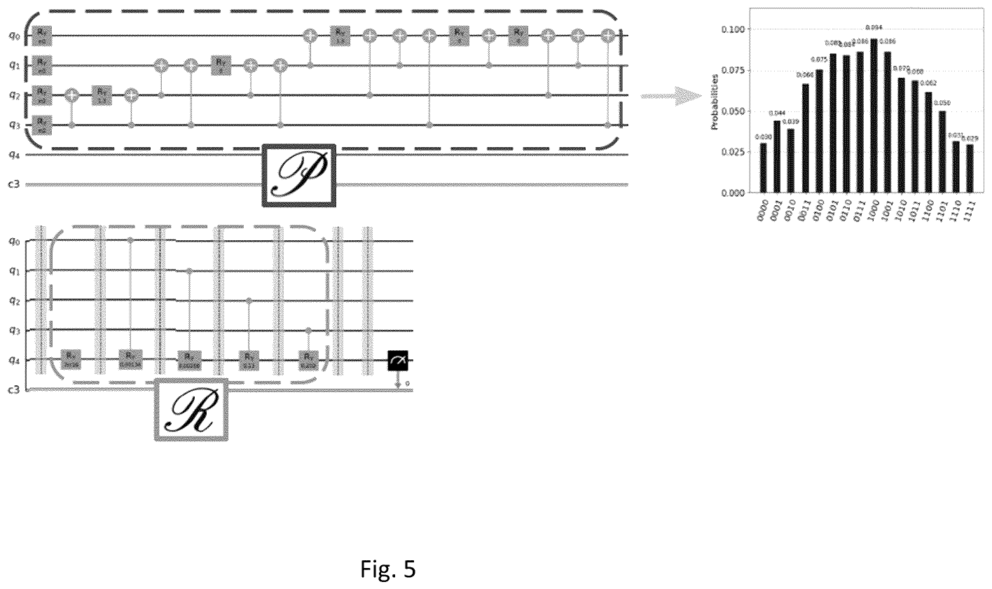

The stochastic function can be converted into a quantum circuit as indicated in FIG. 5 with n qubits q₀-q₃ and one ancilla qubit q₄. The operator A is a combination of an operator P followed by an operator R and indicates the preparation of the stochastic function before it is passed to the quantum processor 50. This will be explained in more detail below. In FIG. 5, five qubits (q₀-q₃ and q₄) are shown which means that 16 values p(i) of the stochastic function f(i) can be represented (but this is not limiting of the invention). More generally, the stochastic function f(i) can be mapped to the interval {0, . . . , N−1} with values of p(i).

The encoding of the values of the function f(i) can be for example, basic encoding, angle encoding, amplitude encoding. In one particular but not limiting example, the values of the function f(i) are then encoded as y-rotations of the qubits q₀-q₃ and this is shown in FIG. 5 which indicates a mapping of the operator P to the values shown on the right side of FIG. 5. The operator P is the operation which encodes the probability values of function f(i) onto the qubits q₀-q₃ and given by (in this case N=4):

P|0 [symbol] ₙ=Σᵢ₌₀^{N-1}p(i)·|i [symbol] ₙn

The qubit q₄ is the ancilla bit and serves to sum the values of the other qubits q₀-q₃. The operator R in FIG. 4 represents this summation operator. The operator A is a combination of the operators P followed by R and is given by:

$${{\vert ψ 〉}_{n + 1} = A \vert 0 〉}_{n + 1} = {\sum }_{0}^{N - 1} \sqrt{p ( i )} \vert i \text{〉(} \sqrt{1 - f ( i )} \vert 0 〉 + \sqrt{f ( i )} \vert 1 \text{〉)}$$

Which implies:

$${}_{n + 1} 〈 1 〉 {〈 ψ 〉}_{n + 1} = {\sum }_{0}^{N - 1} p ( i ) f ( i ) )$$

FIG. 5 shows graphically how the summation operator can be represented. The values can then be read out from the quantum processor 50 using the read-out element 55 and passed to the input/output devices 25.

The configuration method starts at S200 and has the following stages:

In a first step S205, raw data is ingested from the input/output devices 30. This raw data is obtained from multiple sources (for example as batch data or near real-time data). The raw data could be, for example, data relating to industrial processes or sensor data from IoT devices. The data could also be financial data. The raw data is cleaned in step S210 by, for example, removing any data with non-numeric and/or null values.

The cleaned data is preprocessed in step S215 by being normalized. In the case shown in FIGS. 3-5 the data has been normalized to have values between 0 and 1, as explained above.

In a next step S220, the normalized data from step S215 is fitted to a probability distribution fitting. This is shown in FIG. 3 in which the data is fitted substantially to a normal distribution, for example. As noted previously, the data can be fitted to other distributions. Representative parameters of the stochastic data are obtained in step S225. These representative parameters include, but are not limited to, mean and dispersion of the stochastic data input as the raw data in step S205. In the case of multiple ones of the stochastic input variables, i.e., when the input function representative of the input raw data is a multivariate distribution, this fitting is applied to each of the variables. At these steps, the distribution type of the stochastic variables, distribution parameters, and distribution truncation parameters (which can be set by a confidence rate) are determined.

The quantum circuit state is prepared. This step S230 can be divided into a step S240 of mapping the corresponding function values from the data into a quantum circuit via one of several encoding methods, for example via amplitude encoding, angle encoding (e.g., Y-rotations) (see, Woerner, S., & Egger, D. J., “Quantum risk analysis. npj Quantum Information,” 5(1), 1-8 (2019)) and a step S250 of the integration of the probability distribution and, as described with respect to FIGS. 3-5.

The step S240 of the probability distribution integration comprises mapping the determined distribution parameters of the multivariate input function into the quantum circuit through multi-controlled Y-rotations, as seen in FIG. 5.

Function values integration in step S240 is shown in FIG. 5. As described above, the values of the data are mapped into the quantum circuit through multi-controlled Y-rotations. In this case, the angle encoding (e.g., Y-rotations) are applied to an extra ancilla qubit, i.e., q₄ and depend on the corresponding probability values assigned to the rest of the qubits q₀ to q₃ in the previous probability distribution integration.

This method of steps S235 and S240, therefore, allows the user to integrate in a direct, simple way the input stochastic function and its corresponding probabilities.

The integrated values can be read out in step S260.

The outcome of the steps S210 to S240 an automated pipeline that ingests the raw data and configures some parameters associated with the state preparation of the quantum circuit. The steps S210 to S240 are performed by a software module in the conventional processor. Once this process is finished, the algorithm runs, and outputs results which is the quantum state representation of the user classical stochastic problem. This representation is the first, necessary step for the user to access quantum computing algorithms for stochastic problems.

The method of this document enables an abstraction of the quantum circuit interface with the user, minimizing friction, and therefore enabling a useful tool.

The software module can be integrated into any quantum software circuit as a generic input handler for interfacing with data stores, databases (batch processing) or messaging.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto and their equivalents. The entirety of each of the aforementioned documents is incorporated by reference herein.

### References

[1] Montanaro, A. (2015). Quantum speedup of Monte Carlo methods. Proceedings of the Royal Society A: Mathematical, Physical and Engineering Sciences, 471(2181), 20150301

### REFERENCE NUMERALS

10 Computing system
20 Central processing unit
25 Data storage
30 Input/output devices
35 Graphics processing unit
40 Field programmable gate array
50 Quantum processor
55 Read-in/Read-out element
60 Computer network

What is claimed is:

1. A method for establishing a circuit configuration for a data set to carry out a quantum computation on a quantum processor, the method comprising:
ingesting data values of the data set;
fitting the data values to a function f(i); and
converting the data values to qubits (q₀-q₃) by encoding.

2. The method of claim 1, wherein the data values are encoded by angle encoding of the qubits (q₀-q₃).

3. The method of claim 1, further comprising cleaning the data values prior to fitting.

4. The method of claim 1, further comprising normalizing the data values.

5. The method of claim 1, wherein the converting of the data values comprising applying Y-rotations to one or more qubits to represent the data values.

6. The method of claim 1, further comprising integrating by applying the qubits to an ancillary qubit (q₄).

7. The method of claim 6, further comprising reading out a value from the ancillary qubit.

8. The method of claim 1, wherein the function f(i) is a stochastic function.

9. A system for establishing a circuit configuration for a data set to carry out a quantum computation on a quantum processor, the system comprising:
a plurality of input/output devices for reading data values of the data set;
a central processing unit for fitting the data values to a function f(i) and encoding the data values to qubits;
a quantum processor for processing the qubits; and
a read-in/read out element for passing the data values for processing to the quantum processor and reading out a result.

10. The system of claim 9, wherein the data values are encoded by angle encoding of the qubits (q₀-q₃).
